(19) United States
(12) Patent Application Publication
(10) Pub. No.: US 2024/0072361 A1
(43) Pub. Date: Feb. 29, 2024

(54) HOUSEHOLD ENERGY STORAGE SYSTEM AND MODULE FIXING STRUCTURE THEREOF

(71) Applicant: Sungrow Energy Storage Technology Co., Ltd., Hefei (CN)

(72) Inventors: Xiang Shi, Hefei (CN); Shuqiang Huang, Hefei (CN)

(73) Assignee: Sungrow Energy Storage Technology Co., Ltd., Hefei (CN)

(21) Appl. No.: 18/349,810

(22) Filed: Jul. 10, 2023

(30) Foreign Application Priority Data
Aug. 24, 2022 (CN) 202222241717.8

(51) Int. Cl. H01M 50/262; H01G 2/04; H01M 50/209; H01M 50/289

(52) U.S. Cl. CPC H01M 50/262; H01G 2/04; H01M 50/209; H01M 50/289

(57) ABSTRACT

A household energy storage system and a module fixing structure thereof are provided. The module fixing structure of the household energy storage system includes multiple modules and at least one first fixing member. The modules are stacked in at least one stacking direction; the first fixing member stretches across M modules in a stacking direction in which N modules are stacked, and only two ends of the first fixing member are fixed to two of the modules, respectively; N and M each is a positive integer, N is greater than or equal to 3 and M is less than or equal to N−2. In the above module fixing structure, only two modules of the stacked N modules are fixedly connected to the same first fixing member, and the M modules are not fixedly connected to the first fixing member, which reduces the number of fixed connections.

### CROSS REFERENCE TO RELATED APPLICATIONS

This application claims the priority to Chinese Patent Application No. 202222241717.8 titled “HOUSEHOLD ENERGY STORAGE SYSTEM AND MODULE FIXING STRUCTURE THEREOF”, filed with the China National Intellectual Property Administration on Aug. 24, 2022, which is incorporated herein by reference in its entirety.

### FIELD

The present application relates to the field of energy storage technology, and in particular to a household energy storage system and a module fixing structure thereof.

### BACKGROUND

With the development of energy storage technology in the renewable energy industry, household energy storage systems are gradually being promoted and applied. The stacked modular design is usually used in the above household energy storage systems. The modular design is implemented as dividing the entire household energy storage system into multiple modules based on functions, while the stacked modular design is implemented as sequentially stacking the multiple modules in a height direction from bottom to top.

As the height of the stacked modules increases, the modules generally are required to be fixed in order to ensure the stability of the system. However, the conventional fixing manners are complex, which is not convenient for installation and maintenance.

In view of the above, the technical problem to be solved by those skilled in the art is how to fix the modules to improve the convenience of installation and maintenance.

### SUMMARY

In view of this, the object of the present application is to provide a household energy storage system and a module fixing structure thereof, to improve the convenience of installation and maintenance.

In order to realize the above object, the following technical solutions are provided according to the present application.

A module fixing structure of a household energy storage system includes:
multiple modules and at least one first fixing member; where
the multiple modules are stacked in at least one stacking direction;
in the stacking direction in which N modules of the multiple modules are stacked, the first fixing member stretches across M modules of the multiple modules, and only two ends of the first fixing member are fixed to two of the multiple modules, respectively; where

N is a positive integer greater than or equal to 3, and M is a positive integer less than or equal to N−2.

In an embodiment, the number of the first fixing member is at least two; and
the at least two first fixing members stretch across a same number of modules; and/or, the at least two first fixing members stretch across different numbers of modules.

In an embodiment, the stacking direction in which the N modules are stacked is a vertical direction and/or a horizontal direction.

In an embodiment, each of the multiple modules is of a rectangular cuboid shape, the vertical direction is a height direction of the modules, and the horizontal direction is a length direction and/or a width direction of the modules.

In an embodiment, two adjacent modules of the multiple modules fit with each other by positioning in the stacking direction.

In an embodiment, in the stacking direction, one of the two adjacent modules is provided with at least one positioning groove, the other of the two adjacent modules is provided with at least one positioning member, and the positioning member and the positioning groove fit with each other by positioning.

In an embodiment, the number of the at least one positioning member is two or more, and the number of the at least one positioning groove is two or more; at least one of the two or more positioning members is a first positioning member, at least one of the two or more positioning grooves is a first positioning groove, and the first positioning member and the first positioning groove fit with each other by positioning;
at least another one of the two or more positioning members is a second positioning member, at least another one of the two or more positioning grooves is a second positioning groove, and the second positioning member and the second positioning groove fit with each other by positioning; and
a fit accuracy between the first positioning member and the first positioning groove is less than that between the second positioning member and the second positioning groove.

In an embodiment, the stacking direction is a vertical direction, the first positioning member is a handle, the first positioning groove is a handle groove, the handle is arranged at a top of the other of the two adjacent modules, and the handle groove is arranged at a bottom of the one of the two adjacent modules; and
the second positioning member is a positioning rod, and the second positioning groove is a positioning rod groove.

In an embodiment, the first fixing member is fixedly connected to the modules in a detachable manner.

In an embodiment, the module is provided with a first mounting notch, the first mounting notch and the first fixing member fit with each other by positioning and/or the first fixing member and the modules on which the first fixing member is located are flush with each other, and the first fixing member is fixed at the first mounting notch.

In an embodiment, in a case that the first fixing member and the modules on which the first fixing member is located are flush with each other, at least one of the modules is provided with a first flange in a circumferential direction, the first flange has a first flange notch; and the first fixing member includes a first fixing plate and a first protruding portion provided on the first fixing plate;
where the first fixing plate is fixed at the first mounting notch, and the first fixing plate and the modules on which the first fixing member is located are flush with each other; the first protruding portion is arranged at the first flange notch, and the first protruding portion and the first flange are flush with each other and abutted to each other to form a closed loop structure.

In an embodiment, the module fixing structure further includes a second fixing member, where the second fixing member is used to fixedly connect two adjacent modules of the multiple modules in the stacking direction.

In an embodiment, each of the two adjacent modules of the multiple modules is provided with a second mounting notch, the second mounting notch and the second fixing member fit with each other by positioning, and/or the second fixing member and the two adjacent modules to which the second fixing member is connected are flush with each other; and the second fixing member is fixed at the second mounting notch.

In an embodiment, in a case that the second fixing member and the two adjacent modules to which the second fixing member is connected are flush with each other, at least one of the two adjacent modules is provided with a second flange in a circumferential direction, the second flange has a second flange notch; and the second fixing member includes a second fixing plate and a second protruding portion provided on the second fixing plate;
where the second fixing plate is fixed at the second mounting notch, and the second fixing plate and the two adjacent modules to which the second fixing plate is connected are flush with each other; the second protruding portion is arranged at the second flange notch, and the second protruding portion and the second flange at which the second protruding portion is arranged are flush with each other and abutted to each other to form a closed loop structure.

In an embodiment, at least two of the modules are functional modules and at least one of the modules is a structural module; or, at least one of the modules is a functional module and at least two of the modules are structural modules; or, each of the modules is a functional module; and
where the functional module is an energy storage module, a power control module, an inverter module, a photovoltaic power generation module or a heat dissipation module, and the structural module is a base or a top cover.

On the basis of the above module fixing structure, a household energy storage system is further provided according to the present application. The household energy storage system includes the module fixing structure according to any one of the above embodiments.

In the module fixing structure of a household energy storage system according to the present application, the modules are stacked in at least one stacking direction, the first fixing member stretches across M modules in the stacking direction in which N modules are stacked, and only two ends of the first fixing member are fixed to two of the modules, respectively, N is a positive integer greater than or equal to 3, and M is a positive integer less than or equal to N−2. In this way, only two of the stacked N modules are required to be fixedly connected to the same first fixing member, and the M modules are not fixedly connected to the first fixing member, which reduces the number of fixed connections. Accordingly, the first fixing member stretches across the M modules in the stacking direction in which N modules are stacked, which effectively reduces the number of the first fixing member and the number of fixed connections.

Therefore, with the above module fixing structure, the convenience of installation and maintenance is improved.

### BRIEF DESCRIPTION OF THE DRAWINGS

For more clearly illustrating the technical solutions in the embodiments of the present application or in the conventional technology, the accompanying drawings used in the description of the embodiments or the conventional technology will be briefly described hereinafter. Apparently, the accompanying drawings described hereafter illustrate only embodiments of the present application, and other drawings can be obtained by those skilled in the art based on the provided drawings without any creative efforts.

FIG. 1 is a schematic view showing the structure of a module fixing structure in the conventional technology;

FIG. 2 is a schematic view showing the structure of a module fixing structure of a household energy storage system according to a first embodiment of the present application;

FIG. 3 is schematic view showing another structure of the module fixing structure of the household energy storage system according to the first embodiment of the present application;

FIG. 4 is a front view of the structure shown in FIG. 3;

FIG. 5 is a side view of the structure shown in FIG. 3;

FIG. 6 is a schematic view showing the structure of a functional module in FIG. 3;

FIG. 7 is a bottom view of the structure shown in FIG. 6;

FIG. 8 is a schematic view showing the structure of a first fixing member in FIG. 3;

FIG. 9 is a schematic view showing the structure of a second fixing member in FIG. 3;

FIG. 10 is a schematic view showing the structure of a module fixing structure of a household energy storage system according to a second embodiment of the present application;

FIG. 11 is a schematic view showing the structure of a module fixing structure of a household energy storage system according to a third embodiment of the present application; and

FIG. 12 is a schematic view showing the structure of a module fixing structure of a household energy storage system according to a fourth embodiment of the present application.

Reference numerals:

| | | | |
|---|---|---|---|
| 01 | fixing member; | 02 | module; |
| 1 | first fixing member; | 2 | second fixing member; |
| 3 | module; | 4 | first positioning member; |
| 5 | second positioning member; | 6 | first positioning groove; |
| 7 | second positioning groove; | 11 | first fixing plate; |
| 12 | first protruding portion; | 13 | first fixing hole; |
| 111 | fixing portion; | 112 | stretching-across portion; |
| 21 | second fixing plate; | 22 | second protruding portion; |
| 23 | second fixing hole; | 3a | base; |
| 3b | functional module; | 3c | top cover; |
| 31 | first mounting notch; | 32 | first mounting boss; |
| 33 | first flange; | 34 | first flange notch. |

### DETAILED DESCRIPTION OF THE EMBODIMENTS

The technical solutions in the embodiments of the present application are clearly and completely described below in conjunction with the accompanying drawings. Apparently, the described embodiments are only a part of the embodiments of the present application, not all of them. Based on the embodiments in the present application, other embodiments obtained by those skilled in the art without creative efforts fall within the protection scope of the present application.

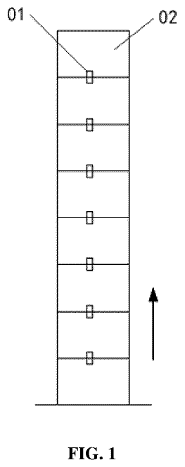

As shown in FIG. 1, in the conventional household energy storage system, eight modules 02 are stacked in sequence in a vertical direction, where the vertical direction is shown by the arrow in FIG. 1.

Two adjacent modules 02 are fixedly connected through a fixing member 01. Specifically, one of the two adjacent modules 02 is fixedly connected to one end of the fixing member 01 and the other of the two adjacent modules 02 is fixedly connected to the other end of the fixing member 01.

In the above fixing structure, seven fixing members 01 are required, i.e. seven fixing connections are performed, which does not facilitate installation and maintenance.

In addition, the household energy storage system is usually installed by a third party or by the customer, and the above fixing structure increases the complexity of on-site installation and on-site maintenance.

In order to facilitate installation and maintenance, a module fixing structure of a household energy storage system is provided according to embodiments of the present application.

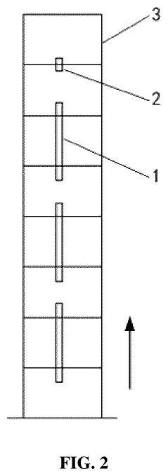

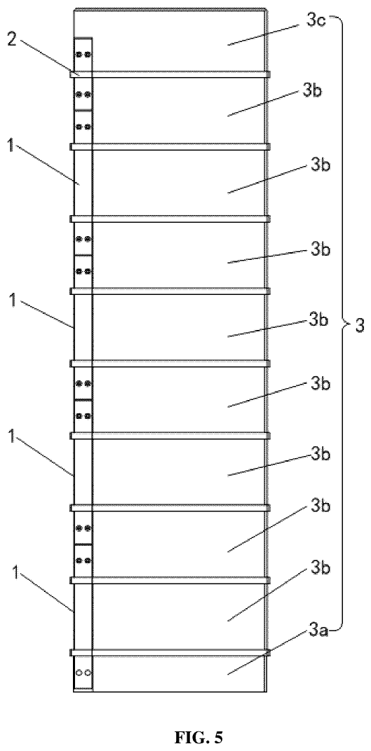

Specifically, as shown in FIGS. 2, 3, 5 and 10 to 12, the module fixing structure according to the present embodiment includes multiple modules 3 and at least one first fixing member 1. The modules 3 are stacked in at least one stacking direction; the first fixing member 1 stretches across M modules 3 of the modules 3 in a stacking direction in which N modules 3 are stacked, and only two ends of the first fixing member 1 are fixed to two of the multiple modules 3, respectively. N is a positive integer greater than or equal to 3, and M is a positive integer less than or equal to N−2.

It should be noted that multiple or a plurality of refers to three or more. In the stacking direction in which the N modules 3 are stacked, one end of the first fixing member 1 is fixed to one module 3 of the N modules, and the other end of the first fixing member 1 is fixed to another module 3 of the N modules; and the M modules are located between the two ends of the first fixing member 1.

As shown in FIG. 8, the first fixing member 1 includes two fixing portions 111 and a stretching-across portion 112 located between the two fixing portions 111. One fixing portion 111 is fixedly connected to one end of the stretching-across portion 112, and the other fixing portion 111 is fixedly connected to the other end of the stretching-across portion 112, and the fixing portion 111 is fixedly connected to the corresponding module 3.

The first fixing member 1 may be a one-piece structure or a split structure, depending on the actual needs.

In the above module fixing structure of a household energy storage system, only two modules 3 of the stacked N modules 3 are required to be fixedly connected to the same first fixing member 1, and the M modules 3 are not fixedly connected to the first fixing member 1, which reduces the number of fixed connections. Accordingly, the first fixing member 1 stretches across the M modules 3 in the stacking direction in which N modules 3 are stacked, which effectively reduces the number of the first fixing member 1 and the number of fixed connections. Therefore, with the above module fixing structure, the convenience of installation and maintenance is improved.

It will be understood that the greater the number of modules 3 across which the first fixing member 1 stretches, the greater the number of fixed connections is reduced by.

In the above module fixing structure, the number of the first fixing member 1 may be one, or two or more. In a case that the number of the first fixing member 1 is at least two, the at least two first fixing members 1 may stretch across the same number of modules 3, and/or, the at least two first fixing members 1 may stretch across different numbers of modules 3.

In the above embodiments, the number of modules 3 across which each of first fixing members 1 stretches is selected according to actual needs, so that the form of fixing can be varied according to the actual situation without changing the number of fixing connections, which improves flexibility and further improves the convenience of installation and maintenance, thereby improving adaptability to complex installation environments.

The above stacking direction may be one, or two or more, depending on the actual needs. The specific direction of the above stacking direction is also selected according to actual needs. Specifically, the stacking direction is a vertical direction and/or a horizontal direction. It is understood that the horizontal direction is perpendicular to the vertical direction.

Accordingly, the stacking direction in which N modules 3 are stacked is a vertical direction and/or a horizontal direction.

The above modules 3 are usually of a rectangular cuboid shape, the above vertical direction is a height direction of the modules 3, and the above horizontal direction is a length direction and/or a width direction of the modules 3.

Specifically, the stacking direction in which N modules 3 are stacked is the height direction of the modules 3, and/or the length direction of the modules 3, and/or the width direction of the modules 3.

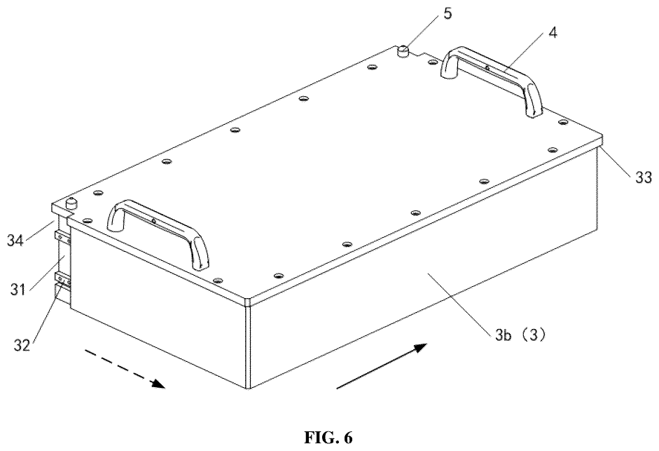

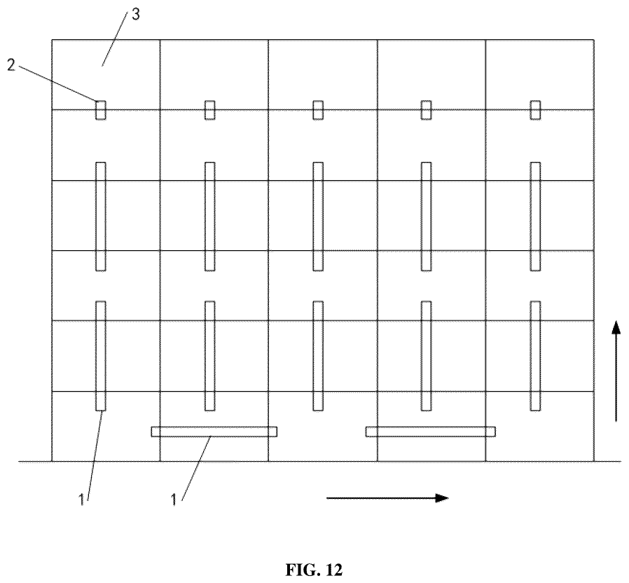

The arrow lines shown in FIGS. 2, 3, 10 and 11 indicate the vertical direction, the solid arrow line in FIG. 6 indicates the length direction of the modules 3, the dashed arrow line in FIG. 6 indicates the width direction of the modules 3, the horizontal arrow line in FIG. 12 indicates the horizontal direction, and the vertical arrow line in FIG. 12 indicates the vertical direction.

To facilitate stacking and fixing, two adjacent modules 3 fit with each other by positioning in the stacking direction. The specific structure of the fitting and positioning of the two modules 3 is selected according to actual needs. Specifically, in the stacking direction, one of the two adjacent modules 3 is provided with at least one positioning groove, the other of the two adjacent modules 3 is provided with at least one positioning member, and the positioning member and the positioning groove fit with each other by positioning.

The specific structure and the specific number of the above positioning member and the positioning groove may be selected according to actual needs, which are not limited in the embodiment.

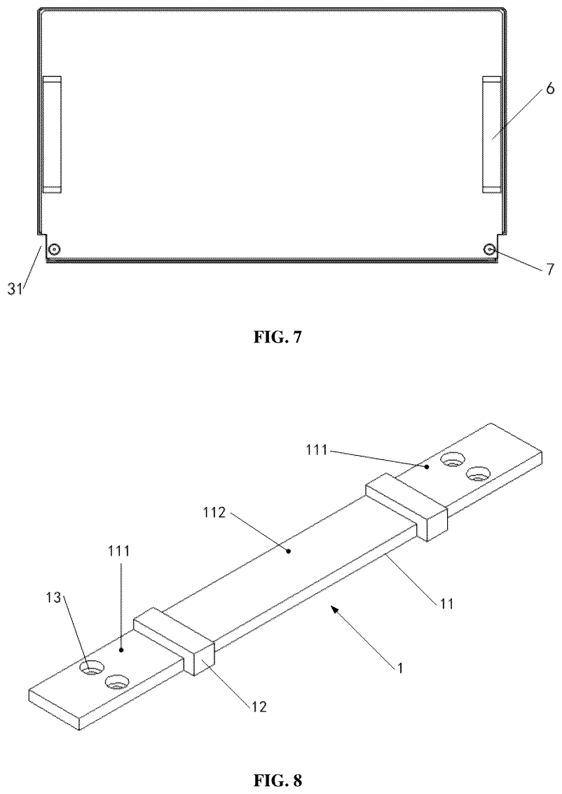

As shown in FIGS. 6 and 7, in order to improve the positioning effect, two or more positioning members and two or more positioning grooves are provided; where at least one of the positioning members is a first positioning member 4, at least one of the positioning grooves is a first positioning groove 6, and the first positioning member 4 and the first positioning groove 6 fit with each other by positioning; at least another one of the positioning members is a second positioning member 5, at least another one of the positioning grooves is a second positioning groove 7, and the second positioning member 5 and the second positioning groove 7 fit with each other by positioning. A fit accuracy between the first positioning member 4 and the first positioning groove 6 is less than that between the second positioning member 5 and the second positioning groove 7.

In the above structure, coarse positioning (i.e., primary positioning) is realized by the first positioning member 4 and the first positioning groove 6, and fine positioning (i.e., secondary positioning) is realized by the second positioning member 5 and the second positioning groove 7. In this way, when the first fixing member 1 is used for fixing in a stretching-across manner, the installation difficulties between the modules 3 due to manufacturing and installation errors can be effectively reduced.

Generally, the modules 3 each is provided with a handle. If the stacking direction is the vertical direction, as shown in FIGS. 6 and 7, the first positioning member 4 is embodied as the handle and the first positioning groove 6 may be a handle groove, where the handle is located at a top of the module 3 having the handle and the handle groove is located at a bottom of the module 3 having the handle groove. In this way, coarse positioning can be realized by the handle and the handle groove, which makes full use of the handle structure of the module 3 itself, and thereby the structure is simplified.

In actual application, alternatively, coarse positioning can be realized by means of other positioning structures, which are not limited to the above embodiments.

In order to facilitate improving the fit accuracy, the second positioning member 5 may be a positioning rod and the second positioning groove 7 may be a positioning rod groove.

In actual application, other positioning structures, such as mortise and tenon joint, may also be used to improve the fit accuracy, which are not limited to the above embodiments.

The specific number and distribution of the first positioning member 4 and the second positioning member 5 are determined according to actual needs. As shown in FIG. 6, for example, the first positioning member 4 is a handle, the module 3 is of a rectangular cuboid shape, and the number of the handle on the module 3 is two and the two handles are distributed in sequence in the length direction of the module 3, and the length direction of the handles parallel to the width direction of the module 3. For example, the second positioning member 5 is a positioning rod, the module 3 is of a rectangular cuboid shape, and the number of the positioning rod is at least two and the at least two positioning rods are distributed in sequence in the length direction, width direction or diagonal direction of the module 3.

To facilitate maintenance of the module 3, the first fixing member 1 may be fixedly connected to the module 3 in a detachable manner. Optionally, the first fixing member 1 and the module 3 are fixedly connected through a threaded connecting member, so that the structure is simple and the fixing is reliable.

Specifically, the first fixing member 1 and module 3 are fixedly connected through screws. As shown in FIG. 8, the first fixing member 1 is provided with first fixing holes 13 for the screws to pass through, and each of the first fixing holes 13 is a countersunk hole. In this way, the screws can be hidden and the appearance is improved.

In actual application, the structure for fixing the first fixing member 1 and the module 3 is not limited to the above way, and the first fixing member 1 may be fixed to the modules 3 by using one of manners or a combination of at least two of the manners of a binding member, a snap-on structure and a clamping member.

The specific structures of the first fixing member 1 and the modules 3 may be selected according to actual needs. As shown in FIGS. 6 and 7, the above module 3 is provided with a first mounting notch 31, and the first fixing member 1 is fixed at the first mounting notch 31.

In an aspect, the first mounting notch 31 and the first fixing member 1 may fit with each other by positioning. In this way, the positioning effect of the first mounting notch 31 on the first fixing member 1 during installation prevents the first fixing member from being deflected during the fixation, thus facilitating fixing the first fixing member and also improving the fixing efficiency.

In another aspect, the first fixing member 1 may be flush with the modules 3 at which the first fixing member 1 is located, so that the first fixing member 1 does not protrude from the modules 3 after the entire first fixing member 1 is mounted at the modules 3, which effectively improves the appearance and reduces the size of the entire structure.

The above two aspects may be combined or not, depending on actual needs, which are not limited in the embodiment.

In the above structure, if the first fixing member 1 is flush with the modules 3 on which the first fixing member 1 is located and at least one module 3 is provided with a first flange 33 in a circumferential direction, the first flange 33 may have a first flange notch 34. As shown in FIG. 8, the first fixing member 1 includes a first fixing plate 11 and a first protruding portion 12 provided on the first fixing plate 11. The first fixing plate 11 is fixed at the first mounting notch 31 and the first fixing plate 11 is flush with the modules 3 at which the first fixing plate 11 is located. The first protruding portion 12 is located at the first flange notch 34, and the first protruding portion 12 and the first flange 33 at which the first protruding portion 12 is located are flush with each other and abutted to each other to form a closed loop structure.

It should be noted that if the first mounting notch 31 and the first fixing member 1 fit with each other by positioning, the first mounting notch 31 and the first fixing plate 11 fit with each other by positioning.

The number of the first protruding portion 12 in the first fixing member 1 is related to the number of modules 3 across which the first fixing member 1 stretches, which is not limited in this embodiment.

To facilitate fixing, the module 3 may be provided with a first mounting boss 32 at the first mounting notch 31. The first mounting boss 32 is provided with a mounting hole for fixing the first fixing member 1.

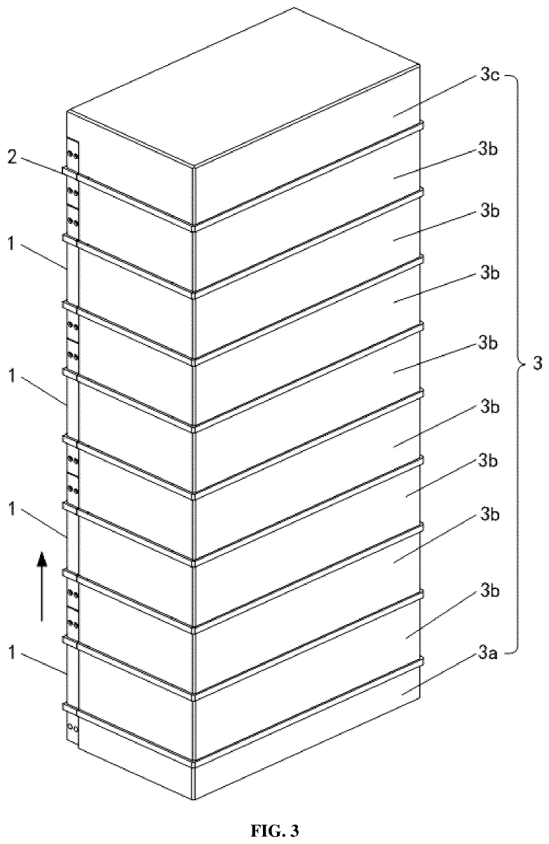

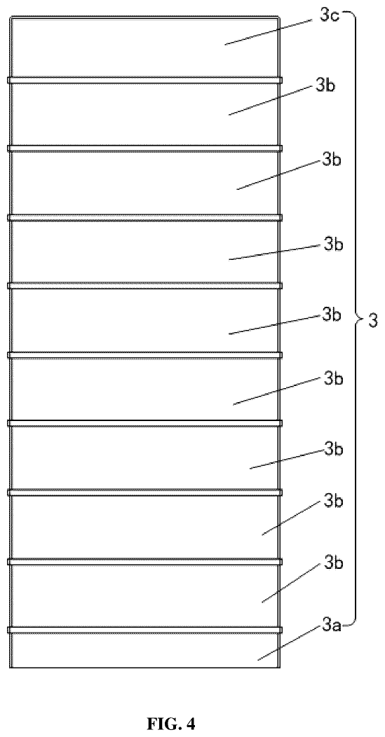

Generally, the module 3 is of a rectangular cuboid shape, the first fixing member 1 may be arranged on an edge of the module 3, as shown in FIGS. 3 to 5. Alternatively, the first fixing member 1 may be arranged between two edges of the module 3.

In the above module fixing structure of a household energy storage system, if after the modules 3 is fixed by using the first fixing member 1, only one module 3 remains unfixed in the stacking direction, and the only one module 3 remained in the stacking direction may be fixed by using a second fixing member 2. Specifically, the second fixing member 2 is fixedly connected to two adjacent modules 3 in the stacking direction. Therefore, based on the above situations, the module fixing structure further includes a second fixing member 2 which is fixedly connected to two adjacent modules 3 in the stacking direction.

To facilitate maintenance of the modules 3, the second fixing member 2 may be fixedly connected to the modules 3 in a detachable manner. Optionally, the second fixing member 2 and the modules 3 are fixedly connected through a threaded connecting member, so that the structure is simple and the fixing is reliable.

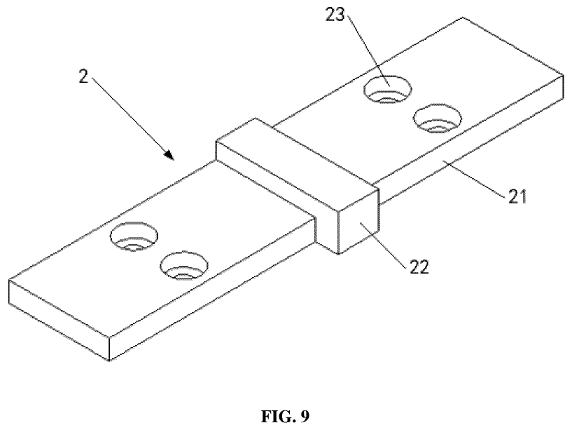

Specifically, the second fixing member 2 and the module 3 are fixedly connected through screws. As shown in FIG. 9, the second fixing member 2 is provided with second fixing holes 23 for the screws to pass through, and each of the second fixing holes 23 is a countersunk hole. In this way, the screws can be hidden and the appearance is improved.

In actual application, the structure for fixing the second fixing member 2 to the modules 3 is not limited to the above manners, and the second fixing member 2 may be fixed to the modules 3 by using one of manners or a combination of at least two of the manners of a binding member, a snap-on structure and a clamping member.

The specific structures of the second fixing member 2 and the modules 3 described above are selected according to actual needs. To facilitate fixing, the module 3 is provided with a second mounting notch, and the second fixing member 2 is fixed at the second mounting notch.

In an aspect, the second mounting notch and the second fixing member 2 may fit with each other by positioning. In this way, the positioning effect of the second mounting notch on the second fixing member 2 during installation prevents the second fixing member 2 from being deflected during the fixation, thus facilitating fixing the second fixing member 2 and also improving the fixing efficiency.

In another aspect, the second fixing member 2 may be flush with the modules 3 at which the second fixing member 2 is located, so that the second fixing member 2 does not protrude from the modules 3 after the entire second fixing member 2 is mounted at the modules 3, which effectively improves the appearance and reduces the size of the entire structure.

The above two aspects may be combined or not, depending on actual needs, which are not limited in the embodiment.

In the above structure, if the second fixing member 1 is flush with the modules 3 at which the second fixing member 1 is located and at least one module 3 is provided with a second flange in a circumferential direction, the second flange may have a second flange notch. As shown in FIG. 9, the second fixing member 2 includes a second fixing plate 21 and a second protruding portion 22 provided on the second fixing plate 21. The second fixing plate 21 is fixed at the second mounting notch, and the second fixing plate 21 is flush with the modules 3 at which the second fixing plate 21 is located. The second protruding portion 22 is located at the second flange notch, and the second protruding portion 22 and the second flange at which the second protruding portion 22 is located are flush with each other and abutted to each other to form a closed loop structure.

It should be noted that the second mounting notch, the second flange and the second flange notch are not shown in the attached drawings. The second mounting notch may be referred to the first mounting notch 31, the second flange may be referred to the first flange 33, and the second flange notch may be referred to the first flange notch 34. If the second mounting notch and the second fixing member 2 fit with each other by positioning, the second mounting notch and the second fixing member 21 fit with each other by positioning.

In the second fixing member 2, the second protruding portion 22 is located in a middle of the second fixing member 2, and the second fixing holes 23 are located at two ends of the second fixing member 2.

Generally, the module 3 is of a rectangular cuboid shape, the second fixing member 2 may be arranged on an edge of the module 3 or between two edges of the module 3.

In the module fixing structure according to the above embodiment, the module 3 refers to a functional module that can be included in the household energy storage system or a structural module that can be stacked in the household energy storage system. The functional module may be an energy storage module, a power control module, an inverter module, or a heat dissipation module, and the above structural module may be a base or a top cover, or the like. If the household energy storage system is a light storage and charging system, alternatively, the functional module may be a photovoltaic power generation module.

In an aspect, at least one module 3 may be a functional module and at least two modules 3 may be structural modules, or at least two modules 3 may be functional modules and at least one module 3 may be a structural module.

In another aspect, each of the modules 3 may be a functional module.

In actual application, if there are more structural modules, e.g. three or more structural modules are provided, each of the modules 3 may be a structural module.

It should be noted that in a case that at least two modules 3 are functional modules, the at least two functional modules may be the same or different; and in a case that at least two modules 3 are structural modules, the at least two structural modules may be the same or different.

In order to more specifically illustrate the technical solutions according to the present application, four embodiments are illustrated hereinafter.

### First Embodiment

As shown in FIGS. 2 and 3, a module fixing structure of a household energy storage system according to a first embodiment includes multiple modules 3, at least one first fixing member 1, and at least one second fixing member 2.

The multiple modules 3 are stacked in a vertical direction. The second fixing member 2 is fixedly connected to two topmost modules 3, and the remaining modules 3 are fixedly connected by the first fixing member 1.

Specifically, the first fixing member 1 extends along a vertical direction, the first fixing member 1 stretches across at least one module 3, and only two ends of the first fixing member 1 are fixed to the other two modules 3, respectively.

As shown in FIG. 2, the number of the modules 3 is eight, the number of the first fixing member 1 is three, each of the first fixing member 1 stretches across one module 3, and the number of the second fixing member 2 is one. As shown in FIG. 3, the number of the modules 3 is ten, the number of the first fixing member 1 is four, each of the first fixing member 1 stretches across one module 3, and the number of the second fixing member 2 is one.

In the first embodiment, the position of the second fixing member 2 may be adjusted, for example the second fixing member 2 is fixedly connected to two bottommost modules 3, which is not limited to the positions shown in FIGS. 2 and 3.

The specific types of the modules 3 may be selected according to actual needs. As shown in FIG. 3, in the vertical direction, a module 3 at the bottommost end is a base 3a, a module 3 at the topmost end is a top cover 3c, and modules 3 between the base 3a and the top cover 3c are functional modules 3b.

In practical applications, the modules 3 may have other types and are not limited to the above embodiment.

### Second Embodiment

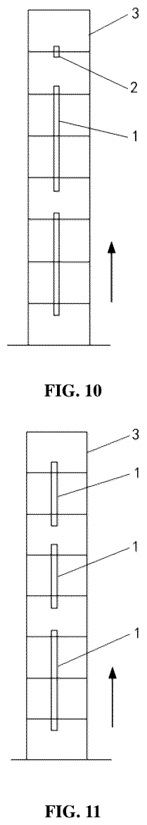

As shown in FIG. 10, the second embodiment differs from the first embodiment mainly in the number of modules 3 across which the first fixing member 1 stretches. Specifically, in the second embodiment, the number of the modules 3 is eight, the first fixing member 1 is two, the number of the second fixing member 2 is one, and each of the first fixing member 1 stretches across two modules 3.

In actual application, the number of the modules 3 across which the first fixing member 1 stretches may be three, or four or more, and is not limited to two.

### Third Embodiment

As shown in FIG. 11, the third embodiment differs from the first embodiment mainly in that no second fixing member is provided.

Specifically, a module fixing structure of a household energy storage system according to the third embodiment includes multiple modules 3 and at least two first fixing members 1.

The multiple modules 3 are stacked in a vertical direction, the first fixing member 1 extends along the vertical direction, and the at least two first fixing members 1 are distributed in sequence in the vertical direction.

The first fixing member 1 stretches across at least one of the modules 3, and only two ends of the first fixing member 1 are fixed to two modules 3, respectively.

In the third embodiment, the number of the modules 3 across which each of the at least two first fixing members 1 stretches is different. Specifically, as shown in FIG. 11, the number of the modules 3 is eight, the number of the first fixing member 1 is three, two of the three first fixing members 1 each stretches across one module 3, and the other one of the three first fixing members 1 stretches across two modules 3.

In the third embodiment, the number of the modules 3 across which the first fixing member 1 stretches maybe other values, which is not limited to one or two.

### Fourth Embodiment

As shown in FIG. 12, the fourth embodiment differs from the first embodiment mainly in the stacking direction of the modules 3.

A module fixing structure of a household energy storage system according to the fourth embodiment includes multiple modules 3, at least two first fixing members 1, and at least one second fixing member 2.

The modules 3 are stacked both in a vertical direction and in a horizontal direction. In the vertical direction, the second fixing member 2 is fixedly connected to two adjacent modules 3, at least one first fixing member 1 stretches across at least one module 3, and only two ends of the first fixing member 1 are fixedly connected to two modules 3, respectively. In the horizontal direction, at least one first fixing member 1 stretches across at least one module 3, and only two ends of the first fixing member 1 are fixedly connected to two modules 3, respectively.

Specifically, the modules 3 stacked in the vertical direction are referred to as module columns, and the modules 3 stacked in the horizontal direction are referred to as module rows. In the vertical direction, in a module row located in the bottom rows, the modules 3 are fixed by the first fixing member 1 in a stretching-across manner. In each of the module columns, the topmost two modules 3 are fixedly connected by the second fixing member 2, and the other modules 3 are fixed by the first fixing member 1 in a stretching-across manner.

Of course, modules in other module rows 3 may be fixed by the first fixing member 1 in a stretching-across manner according to actual needs, which is not limited to the above embodiments.

In actual application, the horizontal direction may be a width direction of the modules 3, which is not limited to the direction shown in FIG. 12; the modules 3 may be stacked in the vertical direction and in the length direction of the modules 3, and also in the width direction of the modules 3, which is not limited to the two stacking directions shown in FIG. 12.

Based on the module fixing structure according to the above embodiments, a household energy storage system is further provided. The household energy storage system includes the module fixing structure according to the above embodiments.

Since the module fixing structure according to the above embodiments has the technical effects described above, and the household energy storage system includes the module fixing structure of a household energy storage system, the above household energy storage system also has the corresponding technical effects, which will not be repeated herein.

The above description of the disclosed embodiments enables those skilled in the art to implement or use the present application. Various modifications to the embodiments are apparent to those skilled in the art, and general principles defined herein can be implemented in other embodiments without departing from the scope of the present application. Therefore, the present application is not limited to the embodiments described herein, and conforms to the widest scope consistent with the principles and novel features disclosed herein.

1. A module fixing structure applicable to a household energy storage system, comprising:
a plurality of modules and at least one first fixing member; wherein
the plurality of modules are stacked in at least one stacking direction;
in a stacking direction of the at least one stacking direction in which N modules of the plurality of modules are stacked, the first fixing member stretches across M modules of the plurality of modules, and only two ends of the first fixing member are fixed to two of the plurality of modules, respectively; wherein
N is a positive integer greater than or equal to 3, and M is a positive integer less than or equal to N−2.

2. The module fixing structure according to claim 1, wherein
the number of the first fixing member is at least two; and
the at least two first fixing members stretch across a same number of modules; and/or, the at least two first fixing members stretch across different numbers of modules.

3. The module fixing structure according to claim 1, wherein the stacking direction in which the N modules are stacked is a vertical direction and/or a horizontal direction.

4. The module fixing structure according to claim 3, wherein each of the plurality of modules is of a rectangular cuboid shape, the vertical direction is a height direction of the modules, and the horizontal direction is a length direction and/or a width direction of the modules.

5. The module fixing structure according to claim 1, wherein two adjacent modules of the plurality of modules fit with each other by positioning in the stacking direction.

6. The module fixing structure according to claim 5, wherein in the stacking direction, one of the two adjacent modules is provided with at least one positioning groove, the other of the two adjacent modules is provided with at least one positioning member, and the positioning member and the positioning groove fit with each other by positioning.

7. The module fixing structure according to claim 6, wherein
the number of the at least one positioning member is two or more, and the number of the at least one positioning groove is two or more; wherein
at least one of the two or more positioning members is a first positioning member, at least one of the two or more positioning grooves is a first positioning groove, and the first positioning member and the first positioning groove fit with each other by positioning; and
at least another one of the two or more positioning members is a second positioning member, at least another one of the two or more positioning grooves is a second positioning groove, and the second positioning member and the second positioning groove fit with each other by positioning; and wherein
a fit accuracy between the first positioning member and the first positioning groove is less than that between the second positioning member and the second positioning groove.

8. The module fixing structure according to claim 7, wherein
the stacking direction is a vertical direction, the first positioning member is a handle, the first positioning groove is a handle groove, the handle is arranged at a top of the other of the two adjacent modules, and the handle groove is arranged at a bottom of the one of the two adjacent modules; and
the second positioning member is a positioning rod, and the second positioning groove is a positioning rod groove.

9. The module fixing structure according to claim 1, wherein the first fixing member is fixedly connected to the modules in a detachable manner.

10. The module fixing structure according to claim 1, wherein the module is provided with a first mounting notch, the first mounting notch and the first fixing member fit with each other by positioning and/or the first fixing member and the modules at which the first fixing member is located are flush with each other; and the first fixing member is fixed at the first mounting notch.

11. The module fixing structure according to claim 10, wherein
in a case that the first fixing member and the modules at which the first fixing member is located are flush with each other, at least one of the modules is provided with a first flange in a circumferential direction, the first flange has a first flange notch; and the first fixing member comprises a first fixing plate and a first protruding portion provided on the first fixing plate; wherein
the first fixing plate is fixed at the first mounting notch, and the first fixing plate and the modules at which the first fixing member is located are flush with each other; the first protruding portion is arranged at the first flange notch, and the first protruding portion and the first flange are flush with each other and abutted to each other to form a closed loop structure.

12. The module fixing structure according to claim 1, further comprising a second fixing member, wherein the second fixing member is configured to fixedly connect two adjacent modules of the plurality of modules in the stacking direction.

13. The module fixing structure according to claim 12, wherein each of the two adjacent modules of the plurality of the modules is provided with a second mounting notch, the second mounting notch and the second fixing member fit with each other by positioning, and/or the second fixing member and the two adjacent modules to which the second fixing member is connected are flush with each other; and the second fixing member is fixed at the second mounting notch.

14. The module fixing structure according to claim 13, wherein
in a case that the second fixing member and the two adjacent modules to which the second fixing member is connected are flush with each other, at least one of the two adjacent modules is provided with a second flange in a circumferential direction, the second flange has a second flange notch; and the second fixing member comprises a second fixing plate and a second protruding portion provided on the second fixing plate;
wherein the second fixing plate is fixed at the second mounting notch, and the second fixing plate and the two adjacent modules to which the second fixing plate is connected are flush with each other; the second protruding portion is arranged at the second flange notch, and the second protruding portion and the second flange at which the second protruding portion is arranged are flush with each other and abutted to each other to form a closed loop structure.

15. The module fixing structure according to claim 1, wherein
at least two of the modules are functional modules and at least one of the modules is a structural module; or, at least one of the modules is a functional module and at least two of the modules are structural modules; or, each of the modules is a functional module; and wherein
the functional module is an energy storage module, a power control module, an inverter module, a photovoltaic power generation module or a heat dissipation module, and the structural module is a base or a top cover.

16. The module fixing structure according to claim 2, wherein
at least two of the modules are functional modules and at least one of the modules is a structural module; or, at least one of the modules is a functional module and at least two of the modules are structural modules; or, each of the modules is a functional module; and wherein
the functional module is an energy storage module, a power control module, an inverter module, a photovoltaic power generation module or a heat dissipation module, and the structural module is a base or a top cover.

17. The module fixing structure according to claim 3, wherein
at least two of the modules are functional modules and at least one of the modules is a structural module; or, at least one of the modules is a functional module and at least two of the modules are structural modules; or, each of the modules is a functional module; and wherein
the functional module is an energy storage module, a power control module, an inverter module, a photovoltaic power generation module or a heat dissipation module, and the structural module is a base or a top cover.

18. A household energy storage system, comprising the module fixing structure according to claim 1.
